(19) United States
(12) Patent Application Publication
(10) Pub. No.: US 2022/0091560 A1
(43) Pub. Date: Mar. 24, 2022

(54) LIGHTGUIDE BASED HOLOGRAPHIC DISPLAY

(71) Applicant: Facebook Technologies, LLC, Menlo Park, CA (US)

(72) Inventors: Changwon Jang, Bellevue, WA (US); Kiseung Bang, Redmond, WA (US); Byoungho Lee, Seoul (KR); Gang Li, Seattle, WA (US); Andrew Maimone, Duvall, WA (US)

(21) Appl. No.: 17/031,204

(22) Filed: Sep. 24, 2020

(51) Int. Cl. G03H 1/22; G02B 27/00; G06F 1/16

(52) U.S. Cl. CPC G03H 1/2205; G02B 27/0093; G03H 1/2286; G03H 1/2294; G06F 1/163; G03H 2240/11; G03H 2001/2207; G03H 2001/2213; G03H 2223/14; G03H 2223/16; G03H 2223/24; G03H 2223/23; G03H 2001/2231

(57) ABSTRACT

A holographic display with a spatial light modulator coupled to a pupil-replicating lightguide is disclosed. The spatial light modulator provides a light beam with spatially modulated amplitude and/or phase. The light beam is replicated by the pupil-replicating lightguide into a plurality of portions. The portions interfere at an exit pupil to provide an image for direct observation by a user. An eye-tracking system may be provided to determine the position of the user pupils, and the spatial modulation of the light beam may be adjusted accordingly to make sure that the optical interference of the beam portions at the eye pupils provides the required image.

### TECHNICAL FIELD

The present disclosure relates to optical devices, and in particular to display systems and modules.

### BACKGROUND

Head mounted displays (HMD), helmet mounted displays, near-eye displays (NED), and the like are being used for displaying virtual reality (VR) content, augmented reality (AR) content, mixed reality (MR) content, etc. Such displays are finding applications in diverse fields including entertainment, education, training and science, to name just a few examples. The displayed VR/AR/MR content can be three-dimensional (3D) to enhance the experience and to match virtual objects to real objects observed by the user.

To provide better optical performance, display systems and modules may include a large number of components such as lenses, waveguides, display panels, gratings, etc. Because a display of an HMD or NED is usually worn on the head of a user, a large, bulky, unbalanced, and/or heavy display device would be cumbersome and may be uncomfortable for the user to wear. Compact, lightweight, and efficient head-mounted display devices and modules are desirable.

### BRIEF DESCRIPTION OF THE DRAWINGS

Exemplary embodiments will now be described in conjunction with the drawings, in which:

FIG. 1 is a schematic view of a replicating lightguide based display of this disclosure;

FIG. 2 is a cross-sectional exploded view of a display embodiment using an illumination replication waveguide;

FIG. 3 is a cross-sectional exploded view of a full-aperture lightguide illuminator display of this disclosure;

FIG. 4 is a cross-sectional exploded view of a display of this disclosure based on a full-aperture light steering stack;

FIG. 5 is a view of an augmented reality (AR) display of this disclosure having a form factor of a pair of eyeglasses; and

FIG. 6 is an isometric view of a head-mounted virtual reality (VR) display of this disclosure.

### DETAILED DESCRIPTION

While the present teachings are described in conjunction with various embodiments and examples, it is not intended that the present teachings be limited to such embodiments. On the contrary, the present teachings encompass various alternatives and equivalents, as will be appreciated by those of skill in the art. All statements herein reciting principles, aspects, and embodiments of this disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

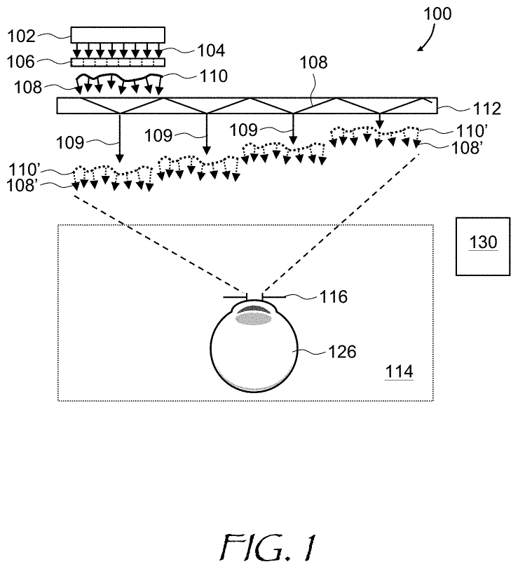

As used herein, the terms “first”, “second”, and so forth are not intended to imply sequential ordering, but rather are intended to distinguish one element from another, unless explicitly stated. Similarly, sequential ordering of method steps does not imply a sequential order of their execution, unless explicitly stated. In FIGS. 1 to 5, similar reference numerals denote similar elements.

A holographic display includes a spatial light modulator (SLM) in an optical configuration that reproduces a wavefront of a light field of an image at an exit pupil of the display. Such an image may be directly observed by a user when the user's eye is placed at the exit pupil. One advantage of a holographic display configuration is that the depth of field is reproduced naturally. A challenge of a holographic display is that the eye needs to remain at the exit pupil to observe the image.

This disclosure utilizes a replicating lightguide that guides image light by series of total internal reflections (TIRs) from their outer surfaces, while out-coupling parallel shifted portions of the image light, thereby providing light coverage across an eyebox of the display, and enabling the image to be observed at a plurality of locations of the eye. In some embodiments, a replicating lightguide is used to replicate the illuminating light beam, operating as a directional backlight for an SLM. In displays disclosed herein, such replicating lightguides are used in a holographic display configuration, enabling one to combine the advantage of depth of field afforded by a holographic display configuration with the ability to observe the displayed scenery at a plurality of locations of the eye afforded by pupil replication.

The light beam spatially modulated by a spatial light modulator (SLM) is replicated by a replicating lightguide into a plurality of portions. Alternatively, the illuminating beam portions may be replicated and directed to SLM for subsequent spatial modulation. The modulated portions interfere at an exit pupil to provide an image for direct observation by a user. An eye-tracking system may be provided to determine the position of the user pupils, and the spatial modulation of the light beam may be adjusted accordingly to make sure that the optical interference of the beam portions at the eye pupils provides the required image.

In accordance with the present disclosure, there is provided a display comprising an illuminator for providing an illuminating light beam. A spatial light modulator (SLM) is operably coupled to the illuminator for receiving and spatially modulating at least a phase of the illuminating light beam to provide an image light beam having a spatially varying wavefront. A first replicating lightguide is operably coupled to the SLM for receiving the image light beam and providing multiple laterally offset portions of the image light beam at an eyebox of the display. The spatially varying wavefront of the image light beam has such a shape that the portions of the image light beam add or subtract coherently at an exit pupil of the display to form an image for direct observation by a user.

The illuminator may include a light source for providing a collimated light beam and a second replicating lightguide configured to receive the collimated light beam and provide multiple portions of the collimated light beam, so as to form the illuminating light beam for coupling to the SLM. The SLM may be e.g. a reflective SLM configured to form the image light beam by reflecting the illuminating light beam with spatially variant phase delays, such that upon reflection, the image light beam propagates back through the second replicating lightguide and towards the first replicating lightguide.

In some embodiments, the first replicating lightguide comprises a grating out-coupler for out-coupling the portions of the image light beam from the first replicating lightguide. The grating out-coupler may be configured to diffusely scatter up to 1% of optical power of at least some of the portions of the image light beam. In some embodiments, the first replicating lightguide may include a grating out-coupler for out-coupling the portions of the image light beam from the first replicating lightguide, and a diffuse scatterer downstream of the grating out-coupler, for scattering at least a portion of optical power of the portions of the image light beam.

The display may further include a controller operably coupled to the SLM. The controller may be configured to compute the shape of the spatially varying wavefront such that the portions of the image light beam add or subtract coherently at the exit pupil of the display to form the image for direct observation by a user, and accordingly to provide a control signal to the SLM to spatially modulate the illuminating light beam to provide the image light beam. The display may further include an eye tracking system for determining a position of an eye pupil of the user. The controller may be operably coupled to the eye tracking system and configured to set a position of the exit pupil of the display based on the position of the eye pupil determined by eye tracking system.

In some embodiments, the display may further include a focusing element downstream of the first replicating waveguide for focusing the image light beam at the exit pupil of the display, and an eye tracking system for determining a position of an eye pupil of the user. In such embodiments, the illuminator may include a light source for providing a collimated light beam, a tiltable reflector operably coupled to the light source for receiving and variably redirecting the collimated light beam, and a second replicating lightguide operably coupled to the tiltable reflector for receiving the collimated light beam and providing multiple portions of the collimated light beam, so as to form the illuminating light beam. The controller may be operably coupled to the tiltable reflector and the eye tracking system, and may be configured to redirect the collimated light beam to shift the exit pupil of the display towards the eye pupil of the user.

In accordance with the present disclosure, there is provided a display comprising a light source for providing a collimated light beam. A tiltable reflector is operably coupled to the light source for receiving and variably redirecting the collimated light beam. A replicating lightguide is operably coupled to the tiltable reflector for receiving the collimated light beam and providing multiple laterally offset parallel portions of the collimated light beam. An SLM is operably coupled to the replicating lightguide for receiving and spatially modulating the portions of the collimated light beam in at least one of amplitude or phase, forming an image light beam. A focusing element is operably coupled to the SLM for focusing the image light beam at an exit pupil of the display, so as to form an image for direct observation by a user. The SLM may be e.g. a reflective SLM configured to form the image light beam by reflecting the collimated light beam with at least one of spatially variant reflectivity or spatially variant phase. Upon reflection, the image light beam propagates back through the replicating lightguide and towards the focusing element.

The display may further include an eye tracking system for determining a position of an eye pupil of the user, and a controller operably coupled to the eye tracking system and the tiltable reflector and configured to operate the tiltable reflector to redirect the collimated light beam to shift the exit pupil of the display to the eye pupil of the user. A focusing element may include a switchable lens. The controller may be operably coupled to the switchable lens and configured to switch the switchable lens to shift the exit pupil of the display to the eye pupil of the user.

In accordance with the present disclosure, there is further provided a display comprising an illuminator for providing a collimated light beam, a replicating lightguide operably coupled to the illuminator for receiving the collimated light beam and providing multiple laterally offset parallel portions of the collimated light beam, an SLM operably coupled to the replicating lightguide for receiving and spatially modulating the portions of the collimated light beam in at least one of amplitude or phase, a redirecting element in an optical path downstream of the SLM for variably redirecting the image light beam, and a focusing element in the optical path downstream of the SLM for focusing the image light beam at an exit pupil of the display to form an image for direct observation by a user. The SLM may be e.g. a reflective SLM configured to form the image light beam by reflecting the portions of the collimated light beam with at least one of spatially variant reflectivity or spatially variant phase. Upon reflection, the image light beam propagates back through the replicating lightguide and towards the redirecting element. The redirecting element may include a stack of Pancharatnam-Berry Phase (PBP) gratings configured to switchably redirect the image light beam. The focusing element may include a diffractive lens, a refractive lens, a Fresnel lens, or a PBP lens, etc. In some embodiments, the display further includes an angular filter disposed in an optical path downstream of the SLM and configured to block higher orders of diffraction due to spatial modulation of the portions of the collimated light beam.

An eye tracking system may be provided for determining a position of an eye pupil of the user of the display. A controller may be operably coupled to the SLM, the redirecting element, and the eye tracking system, and configured to obtain the position of the eye pupil from the eye tracking system, cause the redirecting element to redirect the image light beam towards the position of the eye pupil, and cause the SLM to spatially modulate the portions of the collimated light beam. The focusing element may include a varifocal element operably coupled to the controller. The controller may be configured to adjust a focal length of the varifocal element to shift the exit pupil of the display to the position of the eye pupil.

Referring now to FIG. 1, a display 100 includes an illuminator 102 for providing an illuminating light beam 104. A spatial light modulator (SLM) 106 is optically coupled to the illuminator 102 for receiving and spatially modulating a phase, an amplitude, or both, of the illuminating light beam 104 to provide an image light beam 108 having a spatially varying wavefront 110 having a plurality of ridges and valleys as a result of the spatial modulation of the amplitude and/or phase. A replicating lightguide 112 is optically coupled to the SLM 106 for receiving the image light beam 108 and providing multiple laterally offset portions 108′, or replicas, of the image light beam 108. The portions 108′ of the image light beam 108 have wavefronts 110′. The portions 108′ propagate to an eyebox 114 of the display 100 and undergo optical interference, i.e. coherently add or subtract, depending on local relative optical phase, at an exit pupil 116 of the display 100 in the eyebox 114. Herein, the term “eyebox” means a geometrical area where an image of acceptable quality may be observed by a user of the display 100.

The SLM 106 modulates the image light beam 108 with a pre-computed amplitude and/or phase distribution, such that the portions 108′ of the image light beam 108 of the display add or subtract coherently at an exit pupil 116 to form an image for direct observation by a user's eye 126 located at the exit pupil 116. In some embodiments, the amplitude and phase distribution may be computed by a controller 130 from the image to be displayed by numerically solving a following matrix equation describing the optical interference of the image light beam 108 portions 108′ with wavefronts 110′ at the exit pupil 116:

H=M·S (1)

where H is the desired (target) hologram, S is a solution (amplitude and phase modulation of the illuminating light beam 104), and M is a matrix of transformation accounting for coherent interference of the portions 108′ at the exit pupil 116. For phase-only modulation, the equation may become non-linear. Iterative or encoding-based methods may be employed to compute a hologram from a non-linear equation.

The SLM 106 may operate in transmission or reflection, and may include a liquid crystal (LC) array, a microelectromechanical system (MEMS) reflector array, or be based on any other suitable technology. The replicating lightguide 112 may be e.g. a plano-parallel transparent plate including input and output grating couplers for in-coupling the image light beam 108 and out-coupling portions 108′ at a plurality of offset locations 109, as illustrated in FIG. 1. The grating couplers may include, for example, surface relief grating (SRG) couplers, volume Bragg grating (VBG) couplers, etc. The image light beam 108 propagates in the plano-parallel plate by a series of total internal reflections (TIRs). In some embodiments, the plano-parallel plate may include an embedded partial reflector running parallel to the plate, to increase density of pupil replication.

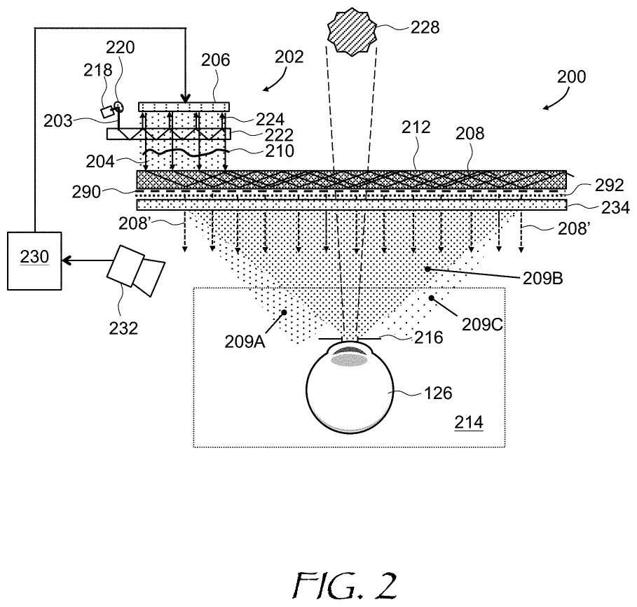

Several embodiments of a holographic display with replication lightguide(s) will now be considered. Referring first to FIG. 2, a display 200 is an embodiment of the display 100 of FIG. 1, and includes similar elements. An illuminator 202 of the display 200 of FIG. 2 includes a light source 218 emitting a collimated light beam 203. The light source 218 is operably coupled, e.g. via a reflector 220, to a source replicating lightguide 222. The source replicating lightguide 222 is configured to provide multiple portions 224 of the collimated light beam 203, so as to form an illuminating light beam 204 for illuminating a reflective SLM 206. The source replicating lightguide 222 may include, for example, input and output grating couplers for in-coupling the collimated light beam 203 and out-coupling the multiple portions 224 of the collimated light beam 203. The reflective SLM 206 is configured to form an image light beam 208 by reflecting the illuminating light beam 204 with spatially variant phase delays and/or spatially modulated amplitude or reflection coefficient. A wavefront of the image light beam 208 is illustrated at 210. Upon reflection, the image light beam 208 propagates back through the source replicating lightguide 222 and towards an image replicating lightguide 212, which is analogous to the replicating waveguide 112 of the display 100 of FIG. 1. The image light beam 208 propagates back through the source replicating lightguide 222 without any further multiple reflections, i.e. straight down in FIG. 2. The image replicating lightguide 212 forms multiple portions 208′ of the image light beam 208. The portions 208′ get focused by a focusing element 234, e.g. a lens, to an exit pupil 216, and optically interfere at the exit pupil 216, forming an image that may be observed by the user's eye 126 placed at the exit pupil 216 (FIG. 2).

The image 212 and/or source 222 replicating lightguides may include grating couplers for in-coupling and out-coupling the illuminating light or image light. The grating couplers may include, for example, SRG couplers, BG couplers, etc. In some embodiments, the plano-parallel plate may include an embedded partial reflector running parallel to the plate, to increase density of pupil replication.

The display 200 may further include a controller 230 operably coupled to the SLM 206. The controller 230 may be configured (e.g. programmed) to compute the shape of the spatially varying wavefront 210 such that the portions 208′ of the image light beam 208 add or subtract coherently at the exit pupil 216 of the display 200 to form the image for direct observation by the user's eye 126. The controller 230 may then provide a control signal to the reflective SLM 206 to spatially modulate the illuminating light beam 204, providing the image light beam 208 at the output. Since the image is formed holographically, complex optical fields representing three-dimensional target images may be formed at the exit pupil 216. The shape of the spatially varying wavefront 210 may be computed such that, for example, a close virtual object 228 appears to the eye 126 as if present at a finite distance from the eye 126, enabling the eye 126 to be naturally focused at the object 228, thereby alleviating a vergence-accommodation conflict.

The image replicating lightguide 212 may include a grating out-coupler 290 for out-coupling the portions 208′ of the image light beam 208 from the image replicating lightguide 212. In some embodiments, the grating out-coupler 290 may be configured to also scatter up a small portion, e.g. up to 0.01%, 0.1%, or up to 1% of intensity of at least some of the portions 208′ of the image light beam 208, within a certain scattering angle, e.g. no greater than 3 degrees, or no greater than 10 degrees, or more. To provide the scattering capacity, a scattering material may be added to the grating out-coupler 290. In some embodiments, the scattering may be achieved by forming the grating coupler using a couple of recording beams, one being a clean plane- or spherical wave beam, and the other being slightly scattered beam. Surface relief gratings (SRG) may also be used. Alternatively, a separate diffuse scatterer 292 may be disposed downstream of the grating out-coupler 290, for scattering at least a portion of optical power of the portions 208′ of the image light beam 208. The function of adding a diffuse scatterer, either to the grating out-coupler 290 or as the separate diffuse scatterer 292, is to reduce the spatial coherence or correlation between individual portions 208′ of the image light beam 208, which may be beneficial for computation and optimization of the shape of the spatially varying wavefront 210, by relieving constraints of such a computation. In some instances, the presence of a diffuse scatterer may further enhance the etendue of the display 200 enabling one e.g. to increase field of view of the display 200. Such a diffuse scatterer may also be added to the display 100 of FIG. 1, either as a separate scatterer downstream of the replicating lightguide 112 or a scattering out-coupler of the replicating lightguide 112.

The display 200 may further include an eye tracking system 232 configured to sense the user's eye 126 and determine a position of an eye pupil in an eyebox 214. The controller 230 may be operably coupled to the eye tracking system 232 to set a position of the exit pupil 216 of the display 200 based on the position of the eye 126 pupil determined by eye tracking system 232. Once the position of the exit pupil 216 is set, the controller 230 may compute the amplitude and/or phase distribution of the image light beam 208 from the image to be displayed by numerically solving an equation describing the optical interference of the image light beam 208 portions 208′ at the location of the exit pupil 216. Other locations at the eyebox 214 may be ignored in this computation to speed up the computation process.

In some embodiments, the reflector 220 is a tiltable reflector that may steer the collimated light beam 203 in a desired direction upon receiving a corresponding control signal from the controller 230. When the collimated light beam 203 is steered by the reflector 220, the angle of incidence of the collimated light beam 203 onto the source replicating waveguide 222 changes. Multiple portions 224 of the collimated light beam 203 are steered accordingly, because the source replicating waveguide 222 preserves the pointing angle of the collimated light beam 203. The multiple portions 224 of the collimated light beam 203 form the illuminating light beam 204, which repeats the steering of the collimating light beam 203. The angle of the illuminating light beam 204 is converted by the focusing element 234 into a position of the focal spot of the illuminating light beam 204. This enables one to steer the image light beam 208 portions 208′ e.g. between a variety of positions 209A, 209B, and 209C. Steering the image light beam 208 portions 208′ enables one to steer a larger portion of the image light beam 208 towards the exit pupil 216, thereby increasing the illumination of the exit pupil 216 of the display 200, and ultimately improving light utilization by the display 200.

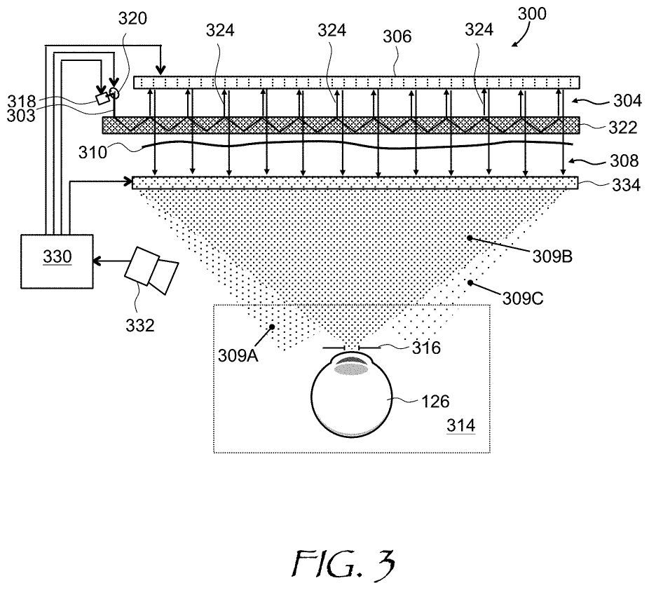

Referring now to FIG. 3, a display 300 includes a light source 318 emitting a collimated light beam 303. The light source 318 is optically coupled to a tiltable reflector 320 which can steer, or variably redirect, the collimated light beam 303 upon receiving a corresponding command from a controller 330 operably coupled to the tiltable reflector 320. A replicating lightguide 322 is optically coupled to the tiltable reflector 320 for receiving the collimated light beam 303 and providing multiple laterally offset parallel portions 324 of the collimated light beam 303 (shown with short upward pointing arrows). Together, the multiple laterally offset parallel portions 324 form an illuminating light beam 304.

An SLM 306 is optically coupled to the replicating lightguide 322. The SLM 306 receives and spatially modulates the illuminating light beam 304 in amplitude, phase, or both, producing an image light beam 308 having a wavefront 310. The SLM 306 is a reflective SLM in this embodiment. A focusing element 334 is optically coupled to the SLM 306. The focusing element 334 focuses the image light beam 308 at an exit pupil 316 of the display 300, forming an image for direct observation by the user's eye 126.

In FIG. 3, the SLM 306 is configured to form the image light beam 308 by reflecting the illuminating light beam 304 with at least one of spatially variant reflectivity or spatially variant phase. Upon reflection, the image light beam 308 propagates back through the replicating lightguide 322 and towards the focusing element 334. More generally, the SLM 306 may operate in transmission or reflection. The SLM 306 may include an LC array, a MEMS reflector array, etc. The replicating lightguide 322 may be a plano-parallel transparent plate including input and output grating couplers for in-coupling the collimated light beam 303 and out-coupling the portions 324 at a plurality of offset locations, as illustrated. The grating couplers may include, for example, SRG couplers, VBG couplers, etc. In some embodiments, the plano-parallel plate may include an embedded partial reflector running parallel to the plate, to increase density of pupil replication.

The display 300 may further include an eye tracking system 332 configured to sense the user's eye 125 and determine a position of an eye pupil relative to an eyebox 314. The controller 330 may be operably coupled to the eye tracking system 332 to operate the tiltable reflector 320 to redirect the collimated light beam 303 to redirect the illuminating light beam 304 between a plurality of positions 309A, 309B, and 309C, and generally towards the pupil of the user's eye 126. The controller 330 may be further configured to set a position of the exit pupil 316 of the display 300 based on the position of the eye 126 pupil determined by eye tracking system 332. Once the position of the exit pupil 316 is set, the controller 330 may compute the amplitude and phase distribution of the image light beam 308 from the image to be displayed at the exit pupil 316. The computation may be dependent upon an optical configuration used.

In some embodiments, the focusing element 334 may include a varifocal element, such as a lens having a switchable focal length, for example, a switchable Pancharatnam-Berry Phase (PBP) lens, a stack of switchable PBP lenses, a metalens, etc. The controller 330 may be operably coupled to the switchable lens(es) and configured to switch the switchable lens(es) to shift the exit pupil 316 of the display 300 to the eye 126 pupil, e.g. to better match the eye relief distance of a particular user. The switchable lens(es) may also be used to change the location of virtual objects in 3D space, for example to alleviate vergence-accommodation conflict. In some embodiments, the focusing element 334 may further include a steering element such as a switchable grating, for example. The varifocal and/or steering focusing element 334 may be used in combination with the tiltable reflector 320 to separate the focus modulation and shift modulation, or use both to expand the shifting angle.

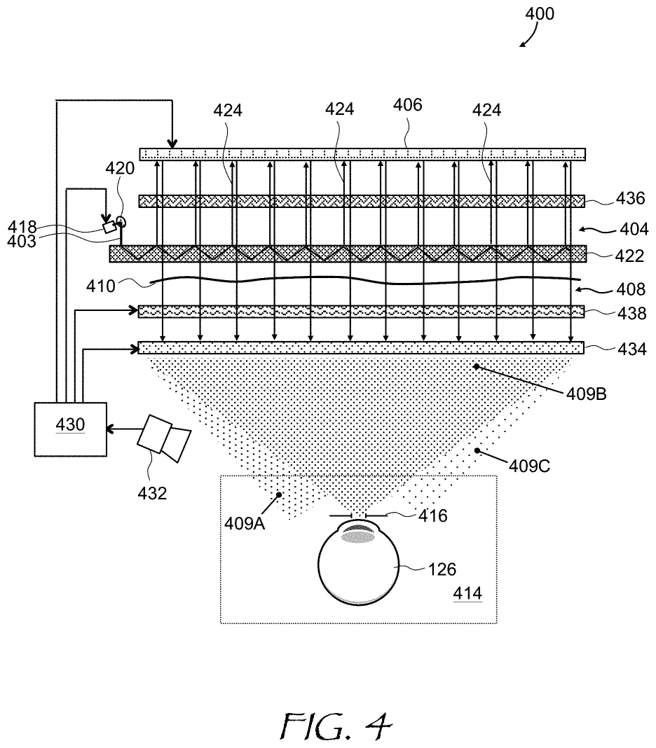

Turning to FIG. 4, a display 400 is similar to the display 300 of FIG. 3, and includes similar elements. The display 400 of FIG. 4 includes an illuminator 418 for providing a collimated light beam 403. A replicating lightguide 422 is optically coupled to the illuminator 418 e.g. by a reflector 420. The replicating lightguide 422 receives the collimated light beam 403 and provides multiple laterally offset parallel portions 424 of the collimated light beam 403. The portions 424 form an illuminating light beam 404, which propagates through an optional angular filter 436 and impinges onto an SLM 406. The SLM 406 receives and spatially modulates the illuminating light beam 404 in at least one of amplitude or phase, so as to encode an image information onto a wavefront 410 of an image light beam 408. In the embodiments shown in FIG. 4, the SLM 406 is a reflective SLM forming the image light beam 408 by reflecting the illuminating light beam 404 with at least one of spatially variant reflectivity or spatially variant optical phase. It is to be understood that the multiple laterally offset parallel portions 424, although shown as perpendicular to the replicating lightguide 422 and the SLM 406, may propagate at an oblique angle w.r.t. the replicating lightguide 422. Furthermore, the image light beam 408, although shown as collimated perpendicular to the replicating lightguide 422 and the SLM 406, may be diverging/converging or may have a complex shape of the wavefront 410.

The image light beam 408 propagates through the angular filter 436. The purpose of the angular filter 436 is to block higher orders of diffraction, which may appear upon spatially modulating the illuminating light beam 404 by the SLM 406. The angular filter 436 may include a volume hologram, for example. Then, the image light beam 408 propagates straight through the replicating lightguide 422, i.e. substantially without being captured or redirected by the replicating lightguide 422. A redirecting element 438 is disposed in an optical path downstream of the SLM for variably redirecting the image light beam 408 between a plurality of positions 409A, 409B, and 409C, and generally towards the pupil of the user's eye 126. To that end, the redirecting element 438 may include an LC steering element, a switchable diffraction grating, a switchable PBP grating or a binary stack of such gratings, a metalens, etc. A focusing element 434 is disposed in the optical path downstream of the SLM 406 for focusing the image light beam 408 at an exit pupil 416 of the display 400 to form an image for direct observation by the user's eye 126. The focusing element may include, for example, a diffractive lens, a refractive lens, a Fresnel lens, a PBP lens, or any combination or stack of such lenses. The order of the redirecting element 438 and the focusing element 434 may be reversed; furthermore, in some embodiments, the focusing 434 and redirecting 438 elements may be combined into a single stack and/or a single optical subassembly enabling variable steering and focusing of the image light 408.

An eye tracking system 432 may be provided. The eye tracking system 432 may be configured to sense the user's eye 126 and determine a position of an eye pupil of the user's eye 126 relative to an eyebox 414. A controller 430 may be operably coupled to the SLM 406, the redirecting element 438, and the eye tracking system 432. The controller 430 may be configured to obtain the position of the eye pupil from the eye tracking system 432, cause the redirecting element 438 to redirect the image light beam 408 towards the eye pupil position, and cause the SLM to spatially modulate the illuminating light beam 404 so as to generate a desired image at the exit pupil 416. The focusing element 434 may include comprises a varifocal element operably coupled to the controller 430. The controller 430 may be configured to adjust a focal length of the varifocal element to shift the exit pupil of the display 400 to the position of the eye pupil of the user's eye 126.

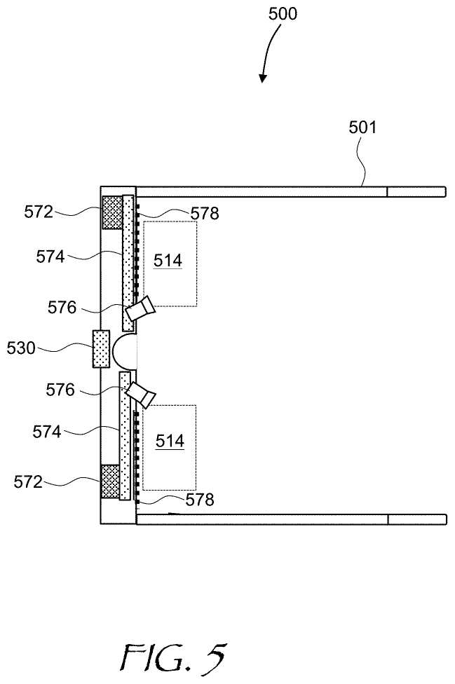

Referring to FIG. 5, an AR/VR near-eye display 500 includes a frame 501 having a form factor of a pair of eyeglasses. The frame 501 supports, for each eye: an illuminator assembly 572; an optical stack 574 coupled to the assembly 572; an eye-tracking camera 576; and a plurality of eyebox illuminators 578 (shown as black dots) for illuminating an eye in an eyebox 514. The eye illuminators 578 may be supported by the optical stack 574. For AR applications, the optical stack 574 can be transparent or translucent to enable the user to view the outside world together with the images projected into each eye and superimposed with the outside world view. The images projected into each eye may include objects disposed with a simulated parallax, so as to appear immersed into the real world view.

The illuminator assembly 572 may include any of the illuminators/light sources disclosed herein, for example the illuminator 102—SLM 106 stack of the display 100 of FIG. 1, the illuminator 202—SLM 206 stack of the display 200 of FIG. 2, the light source 318 of the display 300 of FIG. 3, and/or the illuminator 418 of the display 400 of FIG. 4. The optical stack 574 may include any of the full-aperture optical elements or stacks disclosed herein. Herein, the term “full-aperture” means extending over most of the field of view of a user's eye placed in the eyebox 514. Examples of full-aperture elements or stacks include e.g. the replicating lightguide 112 of the display 100 of FIG. 1, the replicating lightguide 212 of the display 200 of FIG. 2, the stack of the SLM 306, the replicating lightguide 322, and the focusing element 334 of the display 300 of FIG. 3, and/or the stack of the SLM 406, the angular filter 436, the replicating lightguide 422, the redirecting element 438, and the focusing element 434 of the display 400 of FIG. 4.

The purpose of the eye-tracking cameras 576 is to determine position and/or orientation of both eyes of the user. Once the position and orientation of the user's eyes are known, the eye pupil positions are known, a controller 530 of the AR/VR near-eye display 500 may compute the required SLM phase and/or amplitude profiles to form an image at the location of the eye pupils, as well as to redirect light energy to impinge onto the eye pupils. A gaze convergence distance and direction may also be determined. The imagery displayed may be adjusted dynamically to account for the user's gaze, for a better fidelity of immersion of the user into the displayed augmented reality scenery, and/or to provide specific functions of interaction with the augmented reality.

In operation, the eye illuminators 578 illuminate the eyes at the corresponding eyeboxes 514, to enable the eye-tracking cameras 576 to obtain the images of the eyes, as well as to provide reference reflections i.e. glints. The glints may function as reference points in the captured eye image, facilitating the eye gazing direction determination by determining position of the eye pupil images relative to the glints images. To avoid distracting the user with illuminating light, the latter may be made invisible to the user. For example, infrared light may be used to illuminate the eyeboxes 514.

The controller 530 may then process images obtained by the eye-tracking cameras 576 to determine, in real time, the eye gazing directions of both eyes of the user. In some embodiments, the image processing and eye position/orientation determination functions may be performed by a dedicated controller or controllers, of the AR/VR near-eye display 500.

Embodiments of the present disclosure may include, or be implemented in conjunction with, an artificial reality system. An artificial reality system adjusts sensory information about outside world obtained through the senses such as visual information, audio, touch (somatosensation) information, acceleration, balance, etc., in some manner before presentation to a user. By way of non-limiting examples, artificial reality may include virtual reality (VR), augmented reality (AR), mixed reality (MR), hybrid reality, or some combination and/or derivatives thereof. Artificial reality content may include entirely generated content or generated content combined with captured (e.g., real-world) content. The artificial reality content may include video, audio, somatic or haptic feedback, or some combination thereof. Any of this content may be presented in a single channel or in multiple channels, such as in a stereo video that produces a three-dimensional effect to the viewer. Furthermore, in some embodiments, artificial reality may also be associated with applications, products, accessories, services, or some combination thereof, that are used to, for example, create content in artificial reality and/or are otherwise used in (e.g., perform activities in) artificial reality. The artificial reality system that provides the artificial reality content may be implemented on various platforms, including a wearable display such as an HMD connected to a host computer system, a standalone HMD, a near-eye display having a form factor of eyeglasses, a mobile device or computing system, or any other hardware platform capable of providing artificial reality content to one or more viewers.

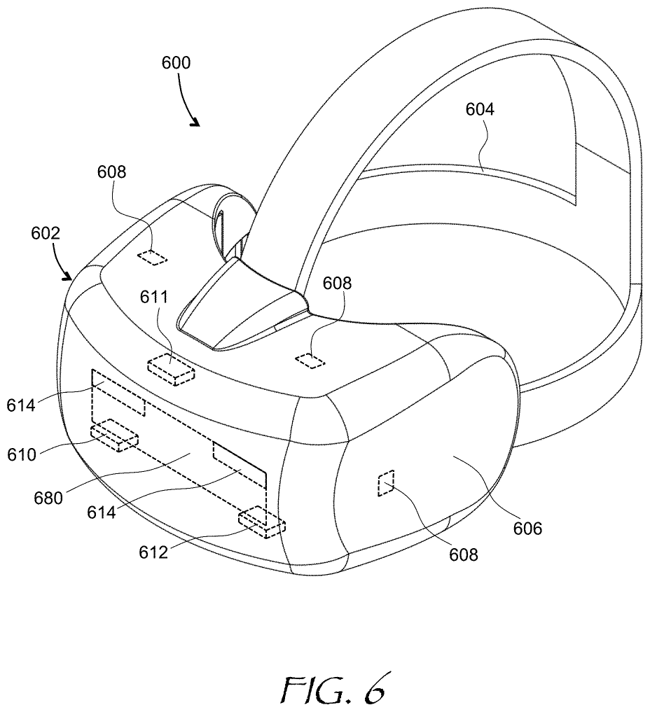

Turning to FIG. 6, an HMD 600 is an example of an AR/VR wearable display system which encloses the user's face, for a greater degree of immersion into the AR/VR environment. Any of the displays considered herein may be used in the HMD 600. The function of the HMD 600 is to augment views of a physical, real-world environment with computer-generated imagery, or to generate the entirely virtual 3D imagery. The HMD 600 may include a front body 602 and a band 604. The front body 602 is configured for placement in front of eyes of a user in a reliable and comfortable manner, and the band 604 may be stretched to secure the front body 602 on the user's head. A display system 680 may be disposed in the front body 602 for presenting AR/VR imagery to the user. The display system 680 may include any of the displays considered herein, e.g. the display 100 of FIG. 1, the display 200 of FIG. 2, the display 300 of FIG. 3, and/or the display 400 of FIG. 1. Sides 606 of the front body 602 may be opaque or transparent.

In some embodiments, the front body 602 includes locators 608 and an inertial measurement unit (IMU) 610 for tracking acceleration of the HMD 600, and position sensors 612 for tracking position of the HMD 600. The IMU 610 is an electronic device that generates data indicating a position of the HMD 600 based on measurement signals received from one or more of position sensors 612, which generate one or more measurement signals in response to motion of the HMD 600. Examples of position sensors 612 include: one or more accelerometers, one or more gyroscopes, one or more magnetometers, another suitable type of sensor that detects motion, a type of sensor used for error correction of the IMU 610, or some combination thereof. The position sensors 612 may be located external to the IMU 610, internal to the IMU 610, or some combination thereof.

The locators 608 are traced by an external imaging device of a virtual reality system, such that the virtual reality system can track the location and orientation of the entire HMD 600. Information generated by the IMU 610 and the position sensors 612 may be compared with the position and orientation obtained by tracking the locators 608, for improved tracking accuracy of position and orientation of the HMD 600. Accurate position and orientation is important for presenting appropriate virtual scenery to the user as the latter moves and turns in 3D space.

The HMD 600 may further include a depth camera assembly (DCA) 611, which captures data describing depth information of a local area surrounding some or all of the HMD 600. To that end, the DCA 611 may include a laser radar (LIDAR), or a similar device. The depth information may be compared with the information from the IMU 610, for better accuracy of determination of position and orientation of the HMD 600 in 3D space.

The HMD 600 may further include an eye tracking system 614 for determining orientation and position of user's eyes in real time. The obtained position and orientation of the eyes also allows the HMD 600 to determine the gaze direction of the user and to adjust the image generated by the display system 680 accordingly. In one embodiment, the vergence, that is, the convergence angle of the user's eyes gaze, is determined. The determined gaze direction and vergence angle may also be used for real-time compensation of visual artifacts dependent on the angle of view and eye position. Furthermore, the determined vergence and gaze angles may be used for interaction with the user, highlighting objects, bringing objects to the foreground, creating additional objects or pointers, etc. An audio system may also be provided including e.g. a set of small speakers built into the front body 602.

The present disclosure is not to be limited in scope by the specific embodiments described herein. Indeed, other various embodiments and modifications, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A display comprising:
an illuminator for providing an illuminating light beam;
a spatial light modulator (SLM) operably coupled to the illuminator for receiving and spatially modulating at least a phase of the illuminating light beam to provide an image light beam having a spatially varying wavefront; and
a first replicating lightguide operably coupled to the SLM for receiving the image light beam and providing multiple laterally offset portions of the image light beam at an eyebox of the display;
wherein the spatially varying wavefront of the image light beam has such a shape that the portions of the image light beam add or subtract coherently at an exit pupil of the display to form an image for direct observation by a user.

2. The display of claim 1, wherein the illuminator comprises a light source for providing a collimated light beam, and a second replicating lightguide configured to receive the collimated light beam and provide multiple portions of the collimated light beam, so as to form the illuminating light beam for coupling to the SLM.

3. The display of claim 2, wherein the SLM is a reflective SLM configured to form the image light beam by reflecting the illuminating light beam with spatially variant phase delays, wherein upon reflection, the image light beam propagates back through the second replicating lightguide and towards the first replicating lightguide.

4. The display of claim 1, wherein the first replicating lightguide comprises a grating out-coupler for out-coupling the portions of the image light beam from the first replicating lightguide, wherein the grating out-coupler is configured to diffusely scatter up to 1% of optical power of at least some of the portions of the image light beam.

5. The display of claim 1, wherein the first replicating lightguide comprises:
a grating out-coupler for out-coupling the portions of the image light beam from the first replicating lightguide; and
a diffuse scatterer downstream of the grating out-coupler, for scattering at least a portion of optical power of the portions of the image light beam.

6. The display of claim 1, further comprising a controller operably coupled to the SLM and configured to:
compute the shape of the spatially varying wavefront such that the portions of the image light beam add or subtract coherently at the exit pupil of the display to form the image for direct observation by a user; and
provide a control signal to the SLM to spatially modulate the illuminating light beam to provide the image light beam.

7. The display of claim 6, further comprising an eye tracking system for determining a position of an eye pupil of the user;
wherein the controller is operably coupled to the eye tracking system, and wherein the controller is configured to set a position of the exit pupil of the display based on the position of the eye pupil determined by eye tracking system.

8. The display of claim 6, further comprising:
a focusing element downstream of the first replicating waveguide for focusing the image light beam at the exit pupil of the display; and
an eye tracking system for determining a position of an eye pupil of the user;
wherein the illuminator comprises:
a light source for providing a collimated light beam;
a tiltable reflector operably coupled to the light source for receiving and variably redirecting the collimated light beam;
a second replicating lightguide operably coupled to the tiltable reflector for receiving the collimated light beam and providing multiple portions of the collimated light beam, so as to form the illuminating light beam; and
wherein the controller is operably coupled to the tiltable reflector and the eye tracking system and is configured to redirect the collimated light beam to shift the exit pupil of the display towards the eye pupil of the user.

9. A display comprising:
a light source for providing a collimated light beam;
a tiltable reflector operably coupled to the light source for receiving and variably redirecting the collimated light beam;
a replicating lightguide operably coupled to the tiltable reflector for receiving the collimated light beam and providing multiple laterally offset parallel portions of the collimated light beam;
a spatial light modulator (SLM) operably coupled to the replicating lightguide for receiving and spatially modulating the portions of the collimated light beam in at least one of amplitude or phase, forming an image light beam; and
a focusing element operably coupled to the SLM for focusing the image light beam at an exit pupil of the display, so as to form an image for direct observation by a user.

10. The display of claim 9, wherein the SLM is a reflective SLM configured to form the image light beam by reflecting the collimated light beam with at least one of spatially variant reflectivity or spatially variant phase, wherein upon reflection, the image light beam propagates back through the replicating lightguide and towards the focusing element.

11. The display of claim 9, further comprising:
an eye tracking system for determining a position of an eye pupil of the user; and
a controller operably coupled to the eye tracking system and the tiltable reflector and configured to operate the tiltable reflector to redirect the collimated light beam to shift the exit pupil of the display to the eye pupil of the user.

12. The display of claim 11, wherein the focusing element comprises a switchable lens, wherein the controller is operably coupled to the switchable lens and configured to switch the switchable lens to shift the exit pupil of the display to the eye pupil of the user.

13. A display comprising:
an illuminator for providing a collimated light beam;
a replicating lightguide operably coupled to the illuminator for receiving the collimated light beam and providing multiple laterally offset parallel portions of the collimated light beam;
a spatial light modulator (SLM) operably coupled to the replicating lightguide for receiving and spatially modulating the portions of the collimated light beam in at least one of amplitude or phase;
a redirecting element in an optical path downstream of the SLM for variably redirecting the image light beam; and
a focusing element in the optical path downstream of the SLM for focusing the image light beam at an exit pupil of the display to form an image for direct observation by a user.

14. The display of claim 13, wherein the SLM is a reflective SLM configured to form the image light beam by reflecting the portions of the collimated light beam with at least one of spatially variant reflectivity or spatially variant phase, wherein upon reflection, the image light beam propagates back through the replicating lightguide and towards the redirecting element.

15. The display of claim 13, wherein the redirecting element comprises a stack of Pancharatnam-Berry Phase (PBP) gratings configured to switchably redirect the image light beam.

16. The display of claim 13, wherein the focusing element comprises at least one of: a diffractive lens, a refractive lens, a Fresnel lens, or Pancharatnam-Berry Phase (PBP) lens.

17. The display of claim 13, further comprising an angular filter disposed in an optical path downstream of the SLM and configured to block higher orders of diffraction due to spatial modulation of the portions of the collimated light beam.

18. The display of claim 13, further comprising an eye tracking system for determining a position of an eye pupil of the user.

19. The display of claim 18, further comprising a controller operably coupled to the SLM, the redirecting element, and the eye tracking system, and configured to:
obtain the position of the eye pupil from the eye tracking system;
cause the redirecting element to redirect the image light beam towards the position of the eye pupil; and
cause the SLM to spatially modulate the portions of the collimated light beam.

20. The display of claim 19, wherein the focusing element comprises a varifocal element operably coupled to the controller, wherein the controller is configured to adjust a focal length of the varifocal element to shift the exit pupil of the display to the position of the eye pupil.
